(19) United States
(12) Patent Application Publication
(10) Pub. No.: US 2024/0356037 A1
(43) Pub. Date: Oct. 24, 2024

(54) Anode Material for an All Solid State Battery, and All Solid State Battery

(71) Applicant: Bayerische Motoren Werke Aktiengesellschaft, Muenchen (DE)

(72) Inventors: Roland JUNG, Muenchen (DE); Raimund KOERVER, Muenchen (DE)

(21) Appl. No.: 18/683,870

(22) PCT Filed: Aug. 2, 2022
(86) PCT No.: PCT/EP2022/071700

§ 371 Date: Feb. 15, 2024

(30) Foreign Application Priority Data
Aug. 17, 2021 (DE) 10 2021 121 348.7

(51) Int. Cl. H01M 4/62; H01M 4/02; H01M 10/0562

(52) U.S. Cl. CPC H01M 4/625; H01M 10/0562; H01M 2004/021; H01M 2004/027; H01M 2300/0071

(57) ABSTRACT

An anode material for an all solid state battery is provided. The anode material includes a multitude of secondary particles, the secondary particles containing a porous matrix material in which primary particles are disposed. The primary particles include at least one of the materials selected from silicon, silicon oxide, graphite, graphene, phosphorus, silicon nitride or hard carbon. The secondary particles are each surrounded by an ion-conducting protective layer. An all solid state battery containing an anode material is also provided.

### BACKGROUND AND SUMMARY

The invention relates to an anode material for an all-solid-state battery and to an all-solid-state battery comprising the anode material.

Lithium ion batteries usually use graphite as anode material, i.e., as active material on the negative electrode side (anode). In order to increase the energy density, it is possible to replace a small proportion of the graphite, for example about 5% to 15%, with silicon or silicon dioxide. This increases the capacity of the anode.

All-solid-state batteries (ASSBs) are a development of lithium ion batteries. The porous, liquid-impregnated separator is replaced here by one or more solids, for example a ceramic such as a sulfidic or oxidic solid-state electrolyte, or a solid-like polymer that may also take the form of a gel. In order that this is still in contact with the active materials of the cathode and anode, this solid has to be integrated into the electrodes. This is accomplished in the form of what are called composite electrodes, i.e. a mixture of the solid-state electrolyte and the active material. Further possible additions are conductive additives or binders for increasing mechanical integrity.

All-solid-state batteries may be constructed either with a lithium metal anode or with a composite anode (typically graphite, silicon or silicon dioxide as active material). In the latter case, the anode material is blended with the solid-state electrolyte and processed to a composite anode.

The object of the invention is to provide an improved anode material for an all-solid-state battery and to provide an improved all-solid-state battery, where the anode material and the all-solid-state battery are especially notable for improved long-term stability.

This object is achieved by an anode material and an all-solid-state battery according to the independent claim(s). Advantageous embodiments and developments of the invention will be apparent from the dependent claims.

In one embodiment of the invention, the anode material for an all-solid-state battery includes a multitude of secondary particles. The secondary particles have a porous matrix material in which primary particles are disposed. The primary particles include at least one of the materials silicon, silicon dioxide, graphite, graphene, phosphorus, silicon nitride or hard carbon. The primary particles especially include a material into which lithium ions or sodium ions can be intercalated with the anode material in the course of charging of a battery, or which forms an alloy with lithium or sodium. The secondary particles are each surrounded by an ion-conducting protective layer.

The invention is especially based on the considerations set out hereinafter: a barrier to the use of all-solid-state batteries is the significant expansion in volume of the anode material in the course of charging of the all-solid-state battery. At the cell level, this may mean an increase in thickness of 10% or more during the charging operation. The “breathing” of the batteries in every cycle with simultaneous stress on the cells constitutes an enormous construction-related problem in the integration of the technology into a vehicle. Moreover, there may be pulverization or cracking of the anode at the cell level, with a correspondingly adverse effect on the service life of the cell. The anode material described herein solves this problem in that the material into which lithium ions or sodium ions are intercalated or alloyed in the course of charging is provided in the form of primary particles that are embedded into a porous matrix material and form secondary particles together with the matrix material. The secondary particles have an ion-conducting protective layer through which lithium ions or sodium ions can penetrate into the secondary particles. At the same time, the protective layer can prevent breakdown of a solid-state electrolyte and/or increase the mechanical stability of the secondary particles. The porous matrix material can partly to fully compensate for an increase in size of the primary particles because of the uptake of lithium ions or sodium ions. The secondary particles at least do not expand significantly, if at all, in the course of charging.

In at least one embodiment, the protective layer is a lithium ion-conducting and/or sodium ion-conducting solid-state electrolyte. The solid-state electrolyte may especially be a lithium ion-conducting garnet.

In a preferred embodiment, the lithium ion-conducting garnet has the composition Li₅₊ₓLa₃(Zrₓ, A₂₋ₓ)O₁₂, where A is at least one of the elements Sc, Ti, V, Y, Nb, Hf, Ta, Si, Ga, Ge and Sn, and where 1.4≤x≤2. In a particularly preferred embodiment, the lithium ion-conducting garnet is Li₇La₃Zr₂O₁₂ (LLZO).

In a preferred embodiment, the protective layer has a thickness of 1 nm to 500 nm, more preferably of 10 nm to 100 nm. A thickness within this range has the advantage that lithium ions or sodium ions can efficiently penetrate the protective layer, and good protection of the solid-state electrolyte from breakdown is simultaneously achieved.

The porous matrix material of the secondary particles preferably includes carbon. The porous matrix material may especially include graphite, amorphous carbon, hard carbon, carbon nanotubes, graphene and/or carbon fibers.

In a preferred embodiment, the secondary particles in the uncharged state of the anode material have pores having a proportion by volume of 20% to 70%, based on the total volume of the secondary particles, especially a proportion by volume of 30% to 60%. The secondary particles having such a proportion by volume of the pores have the advantage that they do not expand significantly, if at all, in the event of expansion of the primary particles since the increasing volume of the primary particles can be accommodated in the pores.

In one embodiment, the primary particles have an average diameter of 10 nm to 500 nm. The primary particles preferably have an average diameter of 0.5 μm to 20 μm, more preferably of 1 μm to 15 μm.

Also described herein is an all-solid-state battery including an anode having the above-described anode material. The above-described advantageous embodiments of the anode material may be implemented in the all-solid-state battery individually or in combination with one another. The all-solid-state battery further includes a cathode and at least one solid-state electrolyte. The solid-state electrolyte preferably includes a sulfide, an oxide, a polymer and/or a gel. It is possible that the solid-state electrolyte includes two or more of these materials.

The anode of the all-solid-state battery may especially be configured as a composite anode containing the anode material and the solid-state electrolyte.

The secondary particles in the uncharged state of the all-solid-state battery advantageously have pores having a proportion by volume of 20% to 70% based on the total volume of the secondary particles. This high proportion by volume of the pores allows the secondary particles to take up lithium ions or sodium ions in the course of charging of the all-solid-state battery without this leading to an expansion in volume of the secondary particles. In this way, adverse effects of the expansion in volume of the anode material that are observed in the case of conventional all-solid-state batteries, for example cracking, are avoided. The all-solid-state battery therefore especially features high long-term stability. The all-solid-state battery described herein is usable advantageously as an energy-storage means in at least partly electrically driven vehicles, for example in electric vehicles or in plug-in hybrid vehicles.

Below is a description of a working example of the invention with reference to the appended drawings. Further details, preferred embodiments and developments of the invention will be apparent therefrom. The individual figures are shown in schematic form.

### BRIEF DESCRIPTION OF THE DRAWINGS

FIG. 1 is a schematic illustration of a cross-section of an all-solid-state battery.

FIG. 2 is a schematic illustration of a secondary particle of the anode material in one working example.

FIG. 3A is a schematic illustration of a region of the anode material in an uncharged state of the all-solid-state battery.

FIG. 3B is a schematic illustration of a region of the anode material in a charged state of the all-solid-state battery.

Components that are the same or have the same effect are each given the same reference numerals in the figures. The components shown and the size ratios of the components to one another should not be regarded as being to scale.

### DETAILED DESCRIPTION OF THE DRAWINGS

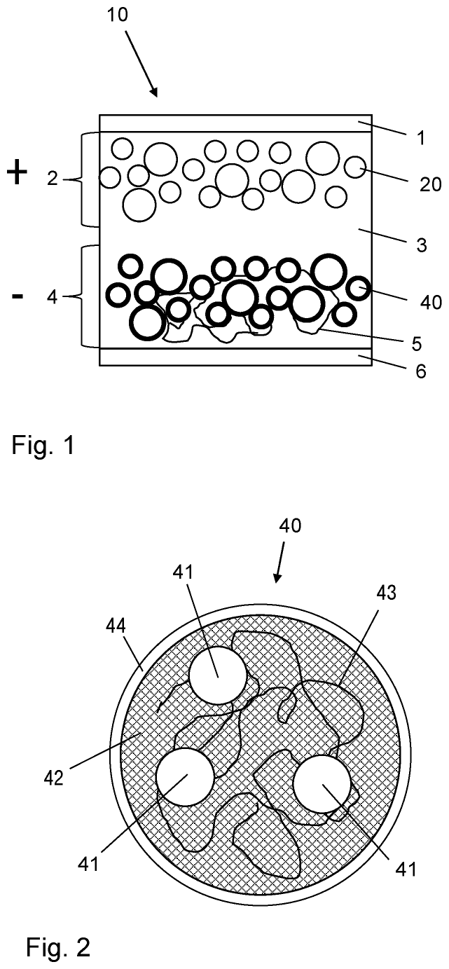

The all-solid-state battery 10 shown schematically in FIG. 1 has a cathode 2 (positive electrode) and an anode 4 (negative electrode). The cathode 2 and the anode 4 each have a current collector 1, 6, where the current collectors may be designed as metal foils. The current collector 1 of the cathode 2 includes aluminum, for example, and the current collector 6 of the anode 4 includes copper.

The cathode 2 and the anode 4 are each formed by a multitude of particles 20, 40, embedded into a solid-state electrolyte 3. It is advantageously also possible to use different solid-state electrolytes in the anode region, cathode region or separator region. In other words, the cathode 2 and the anode 4 each take the form of a composite electrode. The solid-state electrolyte 3 includes, for example, an oxide, a sulfide or a polymer that may also take the form of a gel. There may be variation here in the proportions by volume of the solid-state electrolytes in the anode region, cathode region or separator region. In relation to the anode region and cathode region, the proportion by volume of the solid-state electrolytes may, for example, be 0-50%. It is possible that the solid-state electrolyte 3 in the anode region and cathode region contains a conductivity additive 5 and/or a binder, for example as shown schematically in the region of the anode 4. By comparison with conventional lithium-ion batteries having a liquid electrolyte, no separator is required in an all-solid-state battery 10 between the cathode 2 and the anode 4. However, the use of a solid-state electrolyte 3 may be disadvantageous for the mechanical stability of the all-solid-state battery 10. Especially in the course of charging of an all-solid-state battery, the uptake of lithium ions or sodium ions can lead to an increase in the volume of the anode material. Without suitable countermeasures, this can lead to stresses or even to cracking, and impair the long-term stability of the all-solid-state battery.

In order to avoid the risks associated with the expansion in volume of the anode material, the anode material described herein, includes a multitude of secondary particles 40 that are shown schematically in FIG. 2. The secondary particles 40 have, for example, a diameter of 0.5 μm to 20 μm, preferably of 1 μm to 15 μm. A secondary particle 40 has a porous matrix material 42 into which multiple primary particles 41 are embedded. The porous matrix material 42 is especially a porous carbon matrix material, for example graphite or amorphous carbon. It is possible that the matrix material 42 has a scaffold material, for example carbon fibers 43. The primary particles 41 preferably include or consist of silicon or silicon dioxide. Silicon or silicon dioxide advantageously have high uptake capacity for lithium ions and hence high specific capacity. It is possible that the primary particles 41, in addition to silicon or silicon dioxide, include graphite. Additionally or alternatively, the primary particles 41 may include graphene, phosphorus, silicon nitride or hard carbon.

The secondary particles 40 are surrounded by a protective layer 44. The protective layer 44 is a lithium ion conductor and/or sodium ion conductor, especially a solid-state electrolyte in the form of an oxide or sulfide. Lithium ions or sodium ions, in the course of the charging operation, can penetrate through the protective layer 44 into the secondary particles 40 and be taken up by the primary particles 41. The protective layer 44 protects the primary particles 41 from any reaction with the solid-state electrolyte 3 and in this way especially improves the long-term stability of the all-solid-state battery 10. The protective layer 44 may correspond to a synthetic solid electrolyte interphase (SEI). The thickness of the protective layer 44 is preferably from 1 nm to 500 nm, more preferably from 10 nm to 100 nm.

The protective layer 44 is preferably a lithium ion-conducting garnet, especially having the composition Li₅₊ₓLa₃(Zrₓ, A₂₋ₓ)O₁₂, where A is at least one of the elements Sc, Ti, V, Y, Nb, Hf, Ta, Si, Ga, Ge and Sn, and where 1.4≤x≤2. More preferably, the lithium ion-conducting garnet (with x=2) is Li₇La₃Zr₂O₁₂ (LLZO). LLZO is notable for high ionic conductivity and is resistant to low potentials.

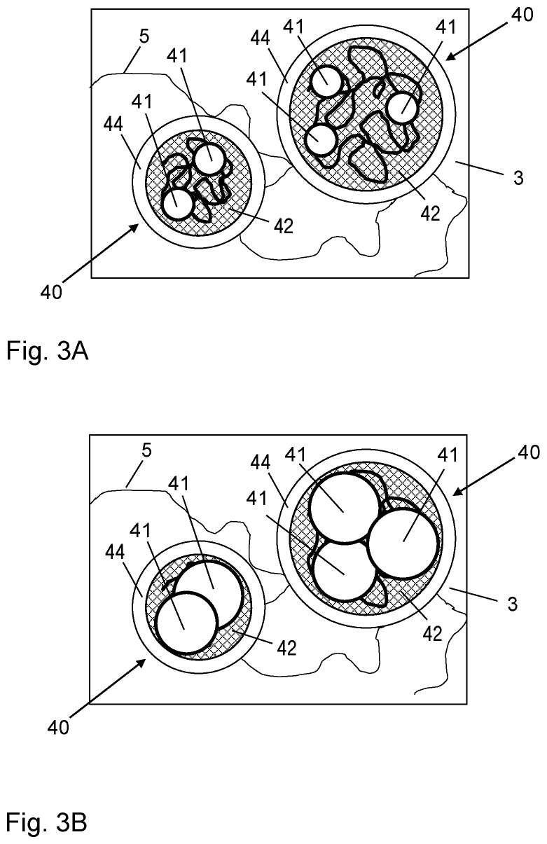

FIGS. 3A and 3B shows schematically the change in the secondary particles 40 when lithium ions are taken up, i.e., especially in a charging operation of the all-solid-state battery. FIG. 3A shows a region of the anode before the charging operation, and FIG. 3B that region after the charging operation. The primary particles 41 in the uncharged state of the all-solid-state battery have, for example, an average diameter of about 10 nm to about 500 nm. The uptake of lithium ions in the charging operation leads to a significant expansion of the primary particles 41. For example, the volume of the primary particles 41 may increase by up to 200% or even by up to 300%. Because the primary particles 41 are embedded into the porous matrix material 42 in the secondary particles 40, this expansion in volume of the primary particles 41, however, advantageously does not lead to any significant expansion, if any, of the secondary particles 40. In order that the secondary particles 40 do not expand significantly, if at all, in the charging operation, it is advantageous when the proportion by volume of the pores in the total volume of the secondary particles 40 in the uncharged state is about 20% to 70%.

There is preferably an increase in the volume of the secondary particles 40 in the course of charging by not more than 50%, not more than 20% or even by not more than 10%.

In this way, it is advantageously possible to reduce stresses in the anode 4 by comparison with conventional all-solid-state batteries and to improve long-term stability. Because of the improved long-term stability, the anode material described herein and the all-solid-state battery with the anode material are especially suitable for use in at least partly electrically driven vehicles.

Even though the invention has been illustrated and described in detail by working examples, the invention is not limited by the working examples. Instead, other variations of the invention may be inferred therefrom by the person skilled in the art without departing from the scope of protection of the invention as defined by the claims.

### LIST OF REFERENCE NUMERALS

1 Cathode current collector
2 Cathode
3 Solid-state electrolyte
4 Anode
5 Conductivity additive
6 Anode current collector
10 All-solid-state battery
20 Cathode material particle
40 Secondary particle
41 Primary particle
42 Porous matrix material
43 Carbon fibers
44 Protective layer

1-14. (canceled)

15. An anode material for an all-solid-state battery, comprising a multitude of secondary particles, wherein
the secondary particles have a porous matrix material in which primary particles are disposed,
the primary particles comprise at least one of the materials selected from silicon, silicon dioxide, graphite, graphene, phosphorus, silicon nitride or hard carbon, and
the secondary particles are each surrounded by an ion-conducting protective layer.

16. The anode material according to claim 15,
wherein the ion-conducting protective layer is a lithium ion-conducting and/or sodium ion-conducting solid-state electrolyte.

17. The anode material according to claim 16,
wherein the ion-conducting protective layer is a lithium ion-conducting garnet.

18. The anode material according to claim 17,
wherein the lithium ion-conducting garnet has a composition Li₅₊ₓLa₃(Zrₓ, A₂₋ₓ)O₁₂, where A is at least one of the elements selected from Sc, Ti, V, Y, Nb, Hf, Ta, Si, Ga, Ge and Sn, and where 1.4≤x≤2.

19. The anode material according to claim 18,
wherein the lithium ion-conducting garnet is Li₇La₃Zr₂O₁₂ (LLZO).

20. The anode material according to claim 15,
wherein the ion-conducting protective layer has a thickness of 1 nm to 500 nm.

21. The anode material according to claim 15,
wherein the porous matrix material comprises carbon, graphite, amorphous carbon, hard carbon, carbon nanotubes, graphene and/or carbon fibers.

22. The anode material according to claim 15,
wherein the secondary particles in an uncharged state of the anode material have pores having a proportion by volume of 20% to 70%, based on the total volume of the secondary particles.

23. The anode material according to claim 15,
wherein the primary particles have an average diameter of 10 nm to 500 nm.

24. The anode material according to claim 15,
wherein the secondary particles have a diameter of 0.5 μm to 20 μm.

25. An all-solid-state battery comprising:
an anode having an anode material;
a cathode; and
at least one solid-state electrolyte,
wherein the anode material comprises a multitude of secondary particles, wherein the secondary particles have a porous matrix material in which primary particles are disposed, the primary particles comprise at least one of the materials selected from silicon, silicon dioxide, graphite, graphene, phosphorus, silicon nitride or hard carbon, and the secondary particles are each surrounded by an ion-conducting protective layer.

26. The all-solid-state battery according to claim 25,
wherein the solid-state electrolyte comprises a sulfide, an oxide, a polymer and/or a gel.

27. The all-solid-state battery according to claim 25,
wherein the anode is a composite anode including the anode material and the solid-state electrolyte.

28. The all-solid-state battery according to claim 25,
wherein the secondary particles in the anode, in an uncharged state of the all-solid-state battery, have pores having a proportion by volume of 20% to 70% based on the total volume of the secondary particles.
